(19) United States
(12) Patent Application Publication
(10) Pub. No.: US 2025/0279729 A1
(43) Pub. Date: Sep. 4, 2025

(54) MANAGING LOSS OF EFFICIENCY DUE TO AN INACTIVE POWER STAGE OF A MULTI-PHASE SWITCHING CONVERTER

(71) Applicant: Shaoxing Yuanfang Semiconductor Co., Ltd., Shaoxing (CN)

(72) Inventors: Arnold J D'Souza, Bangalore (IN); Shyam Somayajula, Bangalore (IN)

(21) Appl. No.: 19/039,810

(22) Filed: Jan. 29, 2025

(30) Foreign Application Priority Data
Feb. 29, 2024 (IN) 202441015118

(51) Int. Cl. H02M 7/25; H02M 1/00; H02M 1/088

(52) U.S. Cl. CPC H02M 7/25; H02M 1/0012; H02M 1/088

(57) ABSTRACT

A switching converter contains multiple power stages and a phase controller that generates a respective control signal to drive each of the power stages. The phase controller drives a first power stage to an active state and a second power stage to an inactive state in a first sequence of cycles of a first duration. The phase controller drives the first power stage to the active state by switching a first control signal between a first state and a second state in each cycle of the first sequence of cycles. If an error current is detected in the second power stage, the phase controller transitions a control signal of the second power stage to the second state before each transition of the first control signal from the second state to the first state in each cycle of the first sequence of cycles following the detection.

### PRIORITY CLAIM

The instant patent application is related to and claims priority from the co-pending India provisional patent application entitled, “TLVR Phase Drop Efficiency Improvement”, Serial No.: 202441015118, Filed: 29 Feb. 2024, Attorney docket no.: AURA-357-INPR, which is incorporated in its entirety herewith to the extent not inconsistent with the description herein.

### BACKGROUND

### Technical Field

Embodiments of the present disclosure relate generally to multi-phase switching converters, and more specifically to managing loss of efficiency due to an inactive power stage of a multi-phase switching converter.

### Related Art

Switching converters refer to components which convert an input AC (alternating current) or DC (direct current) voltage of one magnitude to an output DC voltage of a desired magnitude by employing and operating switch(es), as is well known in the relevant arts. Switching converters find use as stand-alone power supplies, in voltage regulator modules used in several environments such as laptops, mobile phones, etc.

A switching converter often employs multiple power stages, which together generate the regulated DC voltage. Thus, only a subset of the power stages may be used for driving a specific load presented in the corresponding duration. Each power stage generates a corresponding part of the requisite load current in a respective phase of a sequence of phases, and thus such a switching converter is referred to as a multi-phase switching converter.

Each power stage commonly employs a pair of transistors referred to as high-side switch and low-side switch coupled in series, as is well known in the relevant arts. The power stages are controlled by a phase controller using respective control signals. Thus, the control signals are driven to place only a desired set of power stages in active state (and any remaining stages in inactive state) in respective phases, for example, to support the corresponding load current.

There is a recognized loss of efficiency when current flows are found in power stages that are driven in inactive state. Such current flows are found, for example, through a body-diode of a low-side switch of the inactive power stage in implementations in which the outputs of the power stages are coupled electromagnetically.

Aspects of the present disclosure are directed to managing such loss of efficiency due to an inactive power stage of a multi-phase switching converter.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a trans-inductor voltage regulator (TLVR) in an embodiment of the present disclosure.

FIG. 3 is a flow-chart illustrating the manner in which loss of efficiency due to an inactive power stage is managed, according to an aspect of the present disclosure.

FIG. 4 is a block diagram illustrating the implementation of a phase controller in an embodiment of the present disclosure.

FIG. 5 is a block diagram illustrating the implementation of a smart power stage (SPS) in an embodiment of the present disclosure.

FIG. 6 is a block diagram depicting two power stages, in an embodiment of the present disclosure.

FIG. 7 is a timing diagram (not to scale) illustrating example waveforms of voltages and currents at various nodes of an active power stage and two inactive power stages, in an embodiment of the present disclosure.

FIG. 8 is a block diagram of a voltage detector used in a power stage of a TLVR, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

Aspects of the present disclosure are directed to a multi-phase switching converter that generates a regulated supply voltage on a supply node from an input voltage at an input node. The multi-phase switching converter contains multiple power stages and a phase controller that generates a respective control signal to drive each of the power stages. The phase controller operates to drive a first power stage to an active state and a second power stage to an inactive state in a first sequence of cycles of a first duration. The phase controller operates to drive the first power stage to the active state in the first duration by switching the corresponding control signal between a first state and a second state in each cycle of the first sequence of cycles. The phase controller operates to drive the second power stage to the inactive state at a first time instance in the first duration by driving the corresponding control signal to a high-impedance (hi-Z) state. If an error current is detected in the second power stage, the phase controller transitions the control signal of the second power stage to the second state before each transition of the control signal of the first power stage from the second state to the first state in each cycle of the first sequence of cycles following the detection. If no error current is detected, the phase controller maintains the control signal of the second power stage in the hi-Z state. The first duration is a time interval bounded by two consecutive phase-change events.

According to an aspect of the present disclosure, the first and second power stages are electromagnetically coupled, the first state and the second state respectively comprise a logic HIGH state and a logic LOW state. The first duration starts at the first time instance, wherein the second power stage detects the error current when the corresponding control signal of the first power stage is in the first state in a first cycle immediately following the first time instance.

In an embodiment, the second power stage communicates the detection of the error current to the phase controller at the second time instance in the first cycle via an error-detected signal, wherein a logic state of HIGH of the error-detected signal indicates the presence of the error current, and a logic state of LOW of the error-detected signal indicates otherwise.

According to another aspect of the present disclosure, in response to the communication of detection, the phase controller stores the logic state of the error-detected signal corresponding to the second power stage in a memory located internal to the phase controller, and drives the control signal corresponding to the second power stage in each cycle of the first sequence of cycles following the second time instance based on the logic state stored in the memory.

Several aspects of the present disclosure are described below with reference to examples for illustration. However, one skilled in the relevant art will recognize that the disclosure can be practiced without one or more of the specific details or with other methods, components, materials and so forth. In other instances, well known structures, materials, or operations are not shown in detail to avoid obscuring the features of the disclosure. Furthermore, the features/aspects described can be practiced in various combinations, though only some of the combinations are described herein for conciseness.

### 2. Example System

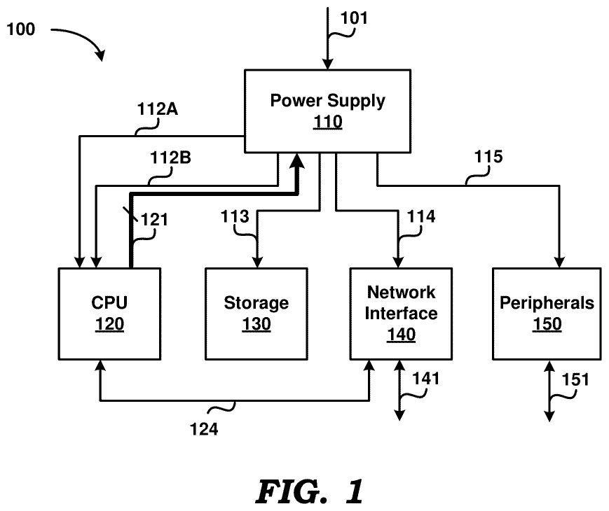

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as, for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific power-save state in which the device/component (e.g., a processor) is currently operating in (in terms of power consumption), such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provide two-way communication between system 100 and a computer network, or in general Internet. Network controller 140 implements the electronic circuitry required to communicate using a specific physical layer and data link layer standard such as Ethernet or Wi-Fi (TM). Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 communicates with external systems and CPU 120 on path 141 and path 124 respectively.

Peripherals 150 represents one or more peripheral circuits, such as, for example, speakers, microphones, user interface devices, etc. Peripherals 150 receives a power supply on path 115, and communicates with external devices on path 151.

Power supply 110 receives one or more sources of power (e.g., battery) on path 101, and operates to provide the desired power supply voltages on paths 112A, 112B, 113, 114 and 115. In an embodiment, power supply 110 is designed to contain one or more DC-DC converters within to generate the power supply voltages. Power supply 110 responds to signals from CPU 120 received on path 121 to reduce/increase current output based on the specific signal (e.g., PS1, PS2 and PS3).

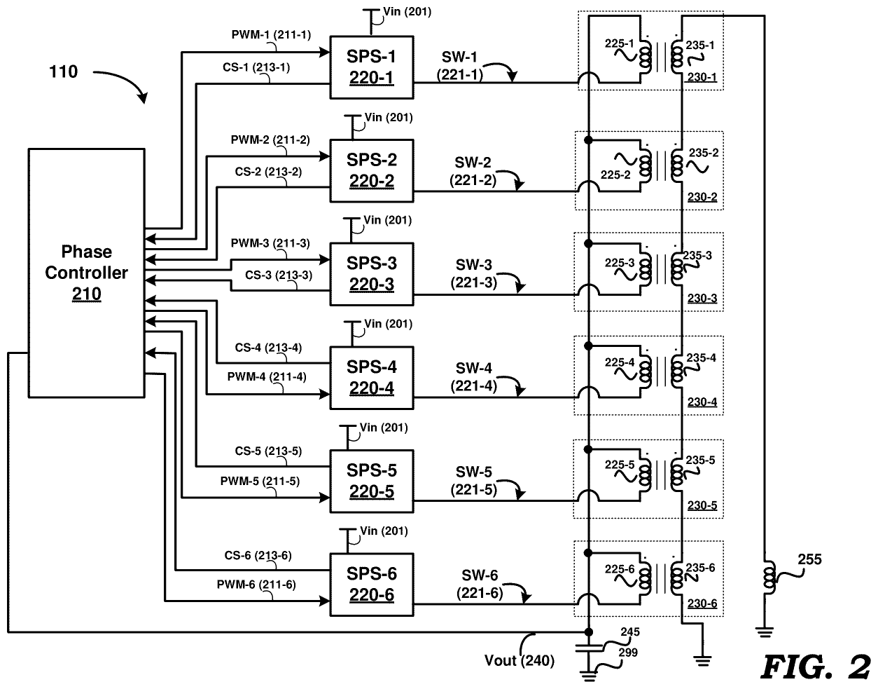

In an embodiment, power supply 110 is a multi-phase trans-inductor voltage regulator (TLVR), sometimes also called processor power module (PPM), and contains one or more step-down switching (buck) converters to generate several smaller voltages from a higher-voltage supply source. In other embodiments however, other types of DC-DC converters such as boost, buck-boost, hysteretic converters etc., can be implemented instead of a buck converter. With a TLVR, multiple devices/ICs requiring different supply voltages can be mounted on the same platform, for example, a computer motherboard of a personal computer (PC). Accordingly, the description is continued with respect to a TLVR as shown in FIG. 2.

### 3. Trans-Inductor Voltage Regulator (TLVR)

FIG. 2 is a block diagram illustrating the details of a Trans-inductor Voltage Regulator (TLVR) in which several aspects of the present disclosure can be implemented. Power supply 110 is implemented as a TLVR (110), and is shown containing phase controller 210, smart power stages (SPS/‘power stages’) SPS-1 (220-1) through SPS-6 (220-6), transformers 230-1 through 230-6, compensation inductor 255 and capacitor 245. Although, the description below is provided in the context of a TLVR, in general, several aspects of the present disclosure are applicable in implementations of a switching converter/regulator in which the outputs of two or more power stages are coupled electromagnetically by any other component or structure(s).

In the example, power supply Vout (240) is shown generated by a 6-phase TLVR (there are six SPSes—220-1 through 220-6). Node/path 240 corresponds to path 112A (supply rail Va) of FIG. 1. Although not shown in FIG. 2, power supply Vb (250) (corresponding to path 112B) of FIG. 1 may similarly be generated by, for example, a 3-phase TLVR. In the interest of conciseness, other power supply circuits that generate supplies on paths 113, 114 and 115 are not shown in FIG. 2.

Power stages 220-1 through 220-6 may be collectively or individually referred to below by respective numeral 220, as will be clear from the context. Also, signals/nodes 211-1 through 211-6, 213-1 through 213-6, 221-1 through 221-6 may be collectively or individually referred to by respective numerals 211, 213 and 221, as will also be clear from the context. Similar convention is followed for other blocks/components/signals throughout the disclosure.

The combination of (corresponding circuitry within) phase controller 210, an SPS, and the corresponding transformer forms one “phase” of each multi-phase TLVR. Thus, for example, SPS-1, transformer 230-1, and the corresponding portion within phase controller 210 represent one phase of the 6-phase TLVR. It is noted here that, while each transformer is shown as a separate component (e.g., 230-1), in another embodiment, only a single larger module (containing multiple transformers) may be employed.

Each SPS may be implemented to contain a high-side switch, a low-side switch, gate-drive circuitry for the two switches, current-sense block and other circuits (not shown). Examples of other circuits include, but are not limited to, temperature monitor circuit, inductor-current sense (or emulation) circuit, etc., to provide information, such as temperature of the SPS/power stage, magnitude of inductor current, etc., to phase controller 210. Each SPS receives a source of power as an input which is connected to the high-side switch. In FIG. 2, the supply source is numbered 201, and has a voltage Vin. In an embodiment, the value of Vin is 21 volts (V), and Va and Vb are respectively 3.3V and 1.8V. Each SPS may also receive a voltage Vcc (202), provided by phase controller 210, on corresponding paths (not shown).

Each SPS communicates with phase controller 210 via corresponding signals PWM and CS. Thus, SPS-1 is shown connected to phase controller 210 through signal/paths PWM-1 (211-1) and CS-1 (213-1). SPS-6 communicates with phase controller 210 via signals PWM-6 (211-6) and CS-6 (213-6). The other SPSes would have similar connections with phase controller 210. Only those signals as relevant to the understanding of the disclosure are depicted in FIG. 2. There may be other communication signals between phase controller 210 and SPSes 220, such as a TMP signal (an output from an SPS to phase controller 210, providing information regarding the temperature in the SPS), a SYNC signal (input to an SPS and may be used by phase controller 210 for the purposes of waking-up the SPS upon power-up of the power supply 110, and also to indicate the power-mode (e.g., PS2, PS3)), etc.

Signal CS (current-sense) is an input to phase controller 210 from an SPS, and contains information representing the magnitude of the inductor-current of that phase. The information can be in the form of a current, voltage, digital values, etc.

Signal PWM is an input to an SPS from phase controller 210, and may be viewed as a ‘control signal’ that controls the operation (ON and OFF states) of the power switches in the SPS of the corresponding phase. In an embodiment of the present disclosure, signal PWM is a pulse-width modulated (PWM) signal. Accordingly, in such an embodiment, signal PWM is a fixed-frequency, variable duty cycle signal. The duty cycle of the PWM signal is set by phase controller 210 and is designed to generate the desired power supply voltage and/or control/change the current supplied by that phase. For example, PWM-1 would have a duty cycle as required for the magnitude of Vout (240) and the current to be provided by SPS-1. However, in general, signal PWM may have other characteristics depending on the specific implementation details of power supply 110.

For example, in another embodiment, phase controller 210 may employ a constant-ON-time control technique to generate Vout. Accordingly, in such an embodiment, signal PWM is a variable frequency, fixed pulse-width (constant-ON-time) signal (i.e., pulse-frequency modulated signal, although the acronym PWM is still used herein to refer to such a signal for ease of reference). The frequency of the signal is generally proportional to the desired regulated voltage (Vout) and the load current. In yet another embodiment, signal PWM can change between a constant-ON time variable-frequency signal and a fixed-frequency pulse-width modulated signal, based on load current requirements, desired efficiency of power supply 110 and other considerations, as would be apparent to one skilled in the relevant arts.

A cycle/period of signal PWM consists of a first interval in which only the high-side (HS) switch of SPS is switched ON, and a second interval in which only the low-side (LS) switch of the SPS is switched ON. The PWM signal (or more typically, drive signals derived from the PWM signal) controls the opening and closing of high-side switch and low-side switch of the SPS. As is well known in the relevant arts, the PWM signals to each SPS of a same multi-phase voltage regulator are staggered, i.e., delayed with respect to each other in phase such that typically no two high-side switches in the converter (i.e., respective SPSes) will be turned-ON at the same time instant. Such a technique is employed for reasons such as, for example, to ensure that the peak instantaneous current drawing from Vin is relatively low at all times, efficiency, reduced ripple in the output voltage, etc.

When logic LOW is detected by the SPS on signal PWM, the low-side switch is turned ON, and when logic HIGH is detected on signal PWM, the high-side switch is turned ON. Upon detecting a high-impedance (hi-Z) state (typically mid-rail voltage between power supply and ground) on signal PWM the SPS turns OFF both its high-side and the low-side switches. Thus, an SPS is said to be ‘active’ when the corresponding PWM signal is toggling between the HIGH and LOW states thereby contributing to generation of the output voltage and current, and is said to be ‘inactive’ when the corresponding PWM signal is in hi-Z state (mid-rail voltage between logic HIGH and logic-LOW voltages). In the inactive state, the power stage does not contribute to generation of the output voltage/current.

Each SPS is coupled to a respective transformer 230 having a primary winding 225 and a secondary winding 235. Thus, SPS-1 (220-1) is shown coupled to transformer 230-1 having primary winding 225-1 and secondary winding 235-1. Primary winding 225 of each transformer is shown connected between switching node SW (221) of the corresponding SPS and node 240 (Vout). The secondary windings of transformers of all SPSes are connected in series between ground (299) and one end of compensation inductor 255. The other end of compensation inductor is connected to ground (299). Thus, the secondary windings of the transformers, the compensation inductor and the respective connections form a closed loop, which is referred to herein as ‘secondary-loop’.

The series connection of secondary windings of the transformers enables faster transient response to changes in load current, as is well known in the relevant arts. The primary and secondary winding of each transformer may be tightly coupled (with a coupling coefficient of close to unity). The primary to secondary turns ratio may typically be 1:1 (or higher). Compensation inductor 255 is designed such that an optimal trade-off between transient performance and loop stability of TLVR is achieved, as is well known in the relevant arts. Although transformers 230 are shown connected external to each SPS, in alternative embodiments, the primary and secondary windings of each transformer can be part of the corresponding SPS also, as would be apparent to a skilled practitioner without departing from the scope and spirit of the present disclosure.

In operation, current flowing through the primary winding of a transformer of an active SPS induces an emf, and therefore a current, in the corresponding secondary winding. The induced current in turn flows through secondary windings of transformers of the inactive SPSes as well as the compensation inductor due to the series connection noted above. As a result, emfs/currents may be induced in the primary windings of the inactive SPSes also.

As also noted above, although the example embodiment illustrated in FIG. 2 depicts a TLVR, aspects of the present disclosure can be equally well applied in other types of multi-phase switching converters containing power stages that are inductively/electromagnetically coupled (e.g., power stages employing coupled-inductors) such that current flowing through the inductor of one power stage can induce current in the inductor of the coupled power stage.

Phase controller 210 controls the operation of the power stages via the control signals noted above to provide various functions including regulating functions to enable the generation of regulated voltages Va and Vb by the corresponding sets of power stages. Accordingly, Vout (240) is shown as being provided as input to phase controller 210, to enable operation of one or more feedback loops within phase controller 210 to regulate Vout (240). Phase controller 210 also receives inductor-current information (current flowing through each of the inductors) from each of the SPSes to enable various operations such as current-mode control of voltage regulation, current limiting, short-circuit protection, and balancing the currents generated by each SPS of a same converter so as to make the currents from each SPS of a converter to be substantially equal in magnitude. Phase controller 210 may additionally perform various other operations which are not noted here in the interest of conciseness.

Phase controller 210 also operates to control the power stages to reduce/increase current output based on the load current. Further, phase controller 210 may also receive signals from CPU 120 that indicate a desired power state (e.g., PS1, PS2, etc. noted above) in which the CPU operates from time to time. In response, phase controller 210 may activate/de-activate one or more of power stages 220 depending on the desired power state, change(s) in values of Vin (201) and/or Vout (240) and the load current. For example, phase controller 210 may inactivate (drop/shed) one or more of power stages 220 when the current requirement (load current) of CPU 120 reduces from a previous value, and may activate presently-inactive power stage(s) when the current requirement (load current) of CPU 120 increases from a previous value. For example, based on load current from CPU 120 (as indicated by the power state noted above), phase controller 210 may employ all 6 power stages (SPS 220-1 through SPS 220-6) of the 6-phase TLVR (with corresponding distribution of current output from each power stage) in order to supply the corresponding load-current to CPU 120 at node Vout (240) in a duration when, for example, CPU 120 is running a graphics application. In other durations, phase controller 210 may employ fewer than 6 power stages to supply the load requirement of CPU 120.

According to aspects of the present disclosure, phase controller 210 in combination with one or more inactive power stages operates to manage loss of efficiency due to inactive power stage(s) of a TLVR 110. The manner in which such loss of efficiency may be managed according to aspects of the present disclosure is described below with examples.

### 4. Flow-Chart

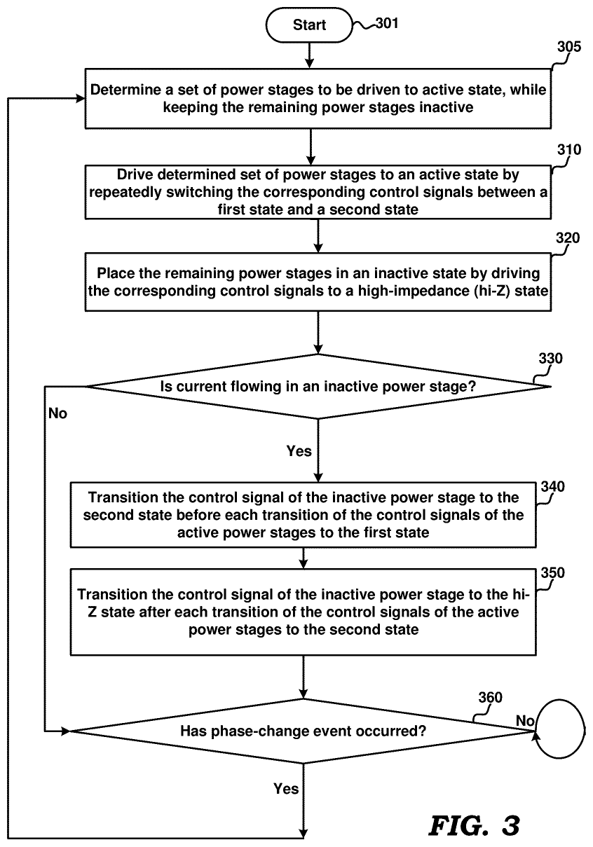

FIG. 3 is a flow-chart illustrating the manner in which a phase controller operates to manage loss of efficiency due to inactive power stage(s) of a TLVR 110, according to an aspect of the present disclosure. The flow-chart is described with respect to the system and TLVR of FIGS. 1 and 2 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow-chart begins in step 301, in which control immediately passes to step 305.

In step 305, phase controller 210 determines a set of power stages to be driven to active state, while keeping the remaining power stages inactive. For example, phase controller 210 may inactivate (drop/shed) one or more of power stages 220, and may activate previously-inactive power stage(s) based on the present load current requirement. Control then passes to step 310 to examine and manage the losses in the new set of inactive power stages.

In step 310, phase controller 210 drives the set of power stages determined in step 305 to an active state by repeatedly switching corresponding control signals between a first state and a second state. For example, the first state may be logic HIGH while the second state may be logic LOW. Control then passes to step 320.

In step 320, phase controller 210 places the remaining power stages in an inactive state by driving corresponding control signals to a high-impedance (hi-Z) state. Control then passes to step 330.

In step 330, phase controller 210 obtains information about whether current is flowing in an inactive power stage. Such information may be obtained by phase controller 210 from the inactive power stage. Current flows found in power stages that are in inactive state may lead to loss of efficiency. If a current flow is present (value “YES”), control passes to step 340, and to step 360 otherwise.

In step 340, phase controller 210 transitions the control signal of the inactive power stage to the second state before each transition of the control signals of the active power stages from the second state to the first state. The transition of the control signal of the inactive power stage causes the low-side switch of the inactive power stage to be turned on, leading to reduced power losses, as explained in further detail in sections below. Control then passes to step 350.

In step 350, phase controller 210 transitions the control signal of the inactive power stage to hi-Z state from the second state after each transition of the control signals of the active power stages to the second state from the first state. Control then passes to step 360.

It may be appreciated that step 330 is performed for all inactive stages. Based on the result of step 330, steps 340 and 350 would be performed for all inactive stages where error current is found to be flowing, with corresponding state changes to control signal of such inactive stages. For inactive stages where no error current is found to be flowing, the corresponding control signals are maintained in the hi-Z state.

Typically, as noted above, the PWM signals to each active SPS of a same multi-phase voltage regulator are staggered with respect to each other. Thus, when more than one power stage is active, the control signals of all inactive power stages that have indicated flow of error current would be transitioned to the second state prior to the earliest transition among the control signals of the active power stages to the first state. Further, the control signals of all inactive power stages that have indicated flow of error current would be transitioned to hi-Z state after the latest transition among the control signals of the active power stages to the second state.

In step 360, phase controller 210 determines if a phase-change event has occurred. A phase-change event is said to occur when the set of active (and thus the inactive) power stages changes. Thus, a phase-change event occurs when a different number of active stages to be operative to support corresponding change in the load current/Vin/Vout etc. Similarly, a phase-change event may also occur when the same number of stages are maintained, but a different set of active stages are chosen, for example, for stress-leveling, as is well known in the relevant arts. Accordingly, in an interval bounded by two consecutive phase-change events, the number of active and inactive phases remains unchanged.

If such an event is determined to have occurred (value “YES”), control passes to step 305. If no such event is determined (value “NO”), control remains in step 360, and phase controller continues to determine if phase-change event has occurred.

The operation of step 310 would cause a current to flow in the high-side switch of the active power stages as well as in the inductors corresponding to the active power stages. Such current can result in an induced current flow in the body-diode of the low-side switch of the inactive power stages due to the coupling via the corresponding transformer windings of the TLVR. Such induced current through the body-diode of the low-side switch of an inactive stage is referred to herein as an “error current”. If such induced current flow in the body-diode occurs in the inactive power stages, the operation of steps 340 and 350 causes the induced current to bypass the body-diode and instead flow through the low-side switch of the inactive stage. Since the ON resistance of the low-side switch would be much lower than the forward resistance of the body-diode, the power loss, and therefore decrease in efficiency, due to current-flow in the body-diode is eliminated.

The implementation details of a phase controller that manages loss of efficiency in an embodiment of the present disclosure are provided next.

### 5. Phase Controller

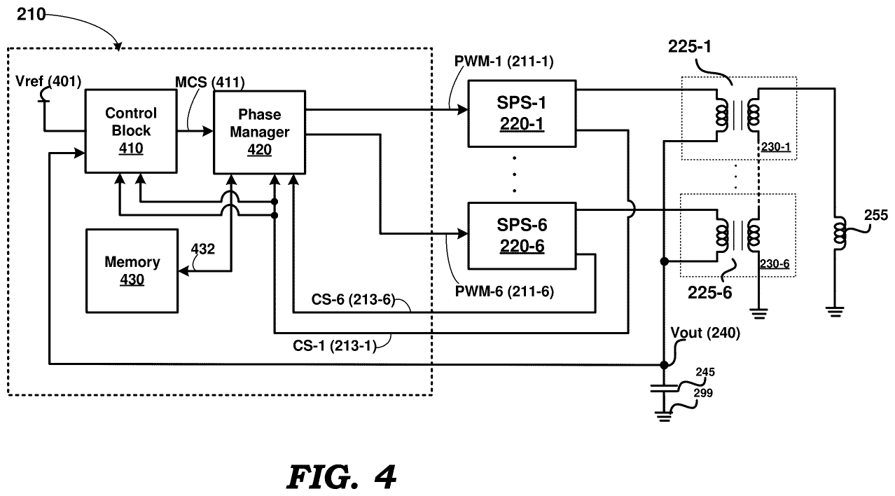

FIG. 4 is a block diagram illustrating the implementation details of a phase controller in an embodiment of the present disclosure. Phase controller 210 is shown as containing control block 410, phase manager 420, and memory 430. Also shown in the Figure for the purpose of ease of understanding and clarity are the power stages 220-1 through 220-6, and the corresponding transformers, compensation inductor 255 and capacitor 245. Also, it is noted herein that only components as relevant to the understanding of the disclosure are depicted in FIG. 4. It is understood that phase controller 210 can contain more or fewer blocks than those shown in FIG. 4. The internal blocks of phase controller 210 may be powered by a source, not shown.

Control block 410 operates one or more closed loops to maintain voltage Vout at a constant desired value, i.e., to regulate Vout. Vref represents the desired target voltage to be supplied at node Vout (240). Vref (401) represents a stable reference DC voltage which is generated internally in phase controller 210 in a known way. Control block 410 receives reference voltage Vref (401), output voltage Vout (240) (or alternatively, some fraction of Vout), and sensed inductor-current magnitudes from the SPSes CS-1 to CS-6 on paths 213-1 to 213-6 respectively. Based on the received inputs, control block generates a master control signal (MCS) 411, which may be a periodic pulse train, the specific characteristics (frequency, duty-cyle, etc.) of which generally depend on the type of control technique employed in phase controller 210. In an embodiment of the present disclosure, current-mode control and fixed-frequency, pulse-width modulation is employed as the control technique. However, in other embodiments, other types of control techniques can be used, such as, for example, voltage-mode control and constant-ON time variable frequency modulation.

Memory 430 represents a non-volatile (persistent) storage facilitating storage and retrieval (via path 432) of data by phase manager 420. Memory 430 may be used to store configuration settings (such as any current or voltage limits, mode of operation, etc.), information communicated by SPSes 220, and any other user inputs (via corresponding interface(s) not shown in FIG. 4). In particular, memory 430 is used to store indication from an inactive power stage regarding whether the inactive power stage has detected induced current-flow through the body-diode of the low-side switch of the inactive power stage, as described in further detail below.

Phase manager 420 receives MCS 411 as well as signals CS-1 to CS-6, and generates signals PWM-1 to PWM-6 on paths 211-1 to 211-6 respectively. According to as aspect of the present disclosure, when an SPS is inactive, the inactive SPS detects whether an induced current flows through the body-diode of the low-side switch in the inactive SPS. If induced current is detected, the SPS indicates via its current-sense (CS) pin to phase controller 210 that induced current has been detected. The use of the CS pin for such purpose is only when the SPS is in the inactive state. Other pins available on an SPS can instead be used for such purpose. Phase manager 420 stores the information regarding induced current flow in memory 430. Phase manager 420 may be implemented in a known way.

Phase manager 420 controls the addition or shedding of phases (power stages) based on triggers to phase-change events as noted above. According to an aspect of the present disclosure, when a phase-change event occurs (e.g., phase manager 420 sheds a phase i.e., places a power stage in an inactive state), phase manager 420 sets the PWM signal of the inactive phase to hi-Z (mid-rail voltage) and waits for a pre-determined duration for feedback from the inactive SPS regarding whether induced-current flows in the body-diode of the low-side switch of the inactive SPS. The pre-determined wait duration may be configured at design time and stored in memory 430, or may be programmed by user (via corresponding means not shown).

Phase manager 420 stores in memory 430 a value (e.g., a bit) indicating whether information/feedback received from the inactive SPS indicates induced-current flow or not. Thereafter, if the stored bit indicates induced-current flow, phase manager 420 drives the PWM signal of the inactive power stage as described in steps 340 and 350 of the flow-chart of FIG. 3. However, if the stored bit does not indicate induced-current flow, phase manager 420 continues to maintain the PWM signal of the inactive stage in the hi-Z state. Such operation of phase manager 420 with respect to the PWM signals of the inactive stages continues till phase manager detects a new phase-change event. Upon detecting the new phase-change event, phase manager 420 clears the information received from the inactive stages regarding induced-current flow, and again evaluates which of the stages should be active and which inactive, receives fresh information regarding induced-current flow from each inactive stage and drives the respective PWM signals of the inactive stages accordingly. It may be appreciated that if none of the power stages is in the inactive state as a result of a phase-change event, phase manager 420 clears the bit for all power stages.

The description is continued with an example implementation of a smart power stage (SPS) in an embodiment of the present disclosure.

### 6. Smart Power Stage (Power Stage/SPS)

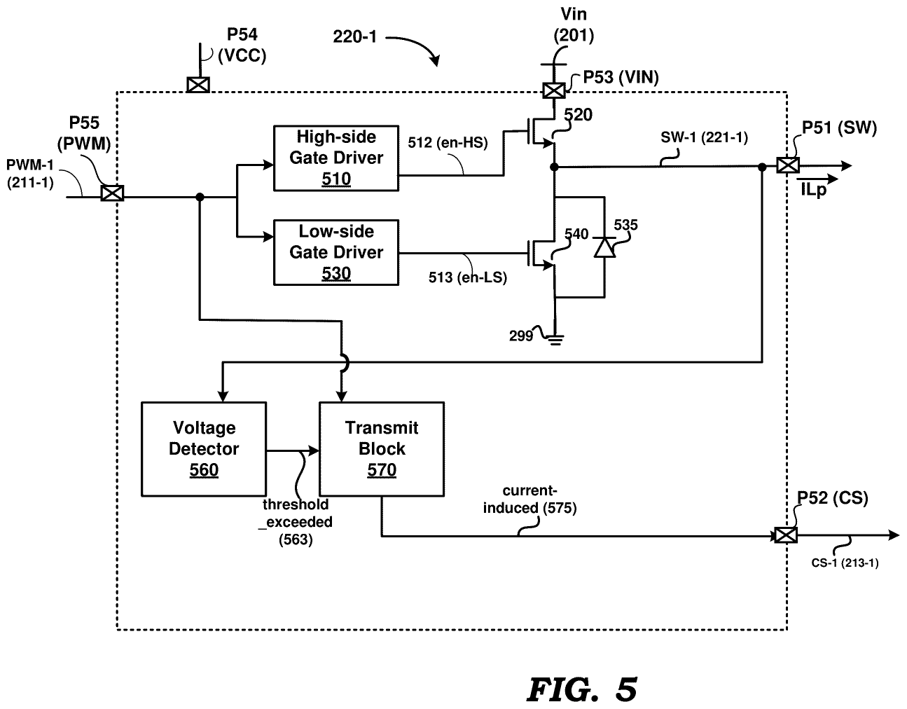

FIG. 5 is a block diagram illustrating the implementation of an SPS in an embodiment of the present disclosure. SPS-1 (220-1) is shown in detail in FIG. 5. The other SPSes of FIG. 2 can also be implemented similar to SPS-1. In the interest of conciseness, only those internal details of the SPS as relevant to the present disclosure are shown in FIG. 5. However, in other embodiments, and in general, an SPS can have more internal circuitry or blocks, such as temperature sensor, bootstrap-capacitor circuitry, level-shifter(s), etc.

SPS-1 is shown containing high-side (HS) gate driver 510, HS switch 520, low-side (LS) gate driver 530, LS switch 540, voltage detector 560, and transmit block 570. Also shown in FIG. 5 is body-diode (between source and drain) 535 of LS switch 540. Vin (201) represents the supply source (as also shown in FIG. 2) and node 221-1 represents the switching node SW-1 of power stage 220-1. P51 through P55 respectively represent pins SW, CS, Vin, Vcc and PWM, when SPS 220-1 is implemented in integrated circuit (IC) form. VCC (202) powers the blocks in SPS 220-1.

Each of HS switch 520 and LS switch 540 may be implemented as transistors (typically power transistors). In the example of FIG. 5, both HS switch 520 and LS switch 540 are N-channel MOSFETs (Metal Oxide Semiconductor Field Effect Transistor). However, switches 520 and 540 may be implemented using other types and combinations of components, as will be apparent to a skilled practitioner. Although gate drivers for HS switch and LS switch are shown as being implemented as separate blocks, in alternative embodiments, a single gate driver block may be employed to generate gate drive signals for both HS and LS switches.

HS gate driver 510 receives signal PWM-1 (211-1), and in response to the logic level of PWM-1 (211), generates the respective appropriate voltage to turn ON or turn OFF HS switch 520 in respective intervals ‘HS-interval’ and ‘LS interval’ of each cycle of operation indicated by PWM-1. LS gate driver 530 receives signal PWM-1 (211-1), and in response to the logic level of PWM-1 (211-1), generates the respective appropriate voltage to turn ON or turn OFF LS switch 540.

Thus, in a ‘HS-interval’ in each cycle of operation indicated by PWM-1, HS switch 520 is ON (and LS switch 540 is OFF) while in an ‘LS interval’ of each cycle of operation, HS switch 520 is OFF (and LS switch 540 is ON). In the example of FIG. 5, when PWM-1 (211-1) is a logic HIGH (i.e., active/asserted, corresponding to the HS-interval), HS gate driver 510 generates appropriate voltage on path 512 (en-HS) to switch ON MOSFET 520, while LS gate driver 540 generates appropriate voltage on path 513 (en-LS) to switch OFF MOSFET 540.

When PWM-1 (211-1) is a logic LOW (inactive/de-asserted, corresponding to the LS-interval), HS gate driver 510 generates appropriate voltage on path 512 to switch OFF MOSFET 520, while LS gate driver 540 generates appropriate voltage on path 513 (en-LS) to switch ON MOSFET 540. When power stage 220-2 is to be in an ‘inactive’ state, PWM-1 is a high-impedance (hi-Z). Consequently, both HS switch 520 and LS switch 540 are OFF. HS gate driver 510 and LS gate driver 530 may be implemented in a known way.

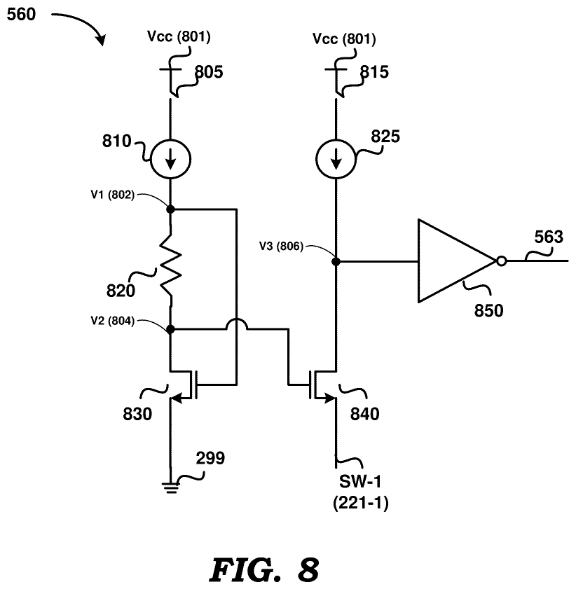

Voltage detector 560 is shown connected to node SW-1 (221), and operates to determine whether the body-diode 535 is conducting or not (i.e., whether a current is flowing through the body-diode or not) by measuring the voltage at node SW-1. When body-diode 535 is conducting a current, the voltage at node SW-1 should be less than (or equal to) ground 299 (0V) by a magnitude equal to the cut-in voltage of body-diode 535. Voltage detector 560 provides a binary output on path 563 (threshold_exceeded) to transmit block 570, the binary output indicating whether body-diode 535 is conducting current or not. An example implementation of voltage detector 560 is described below with reference to FIG. 8.

Transmit block 570 receives PWM-1 and binary output signal (563) of voltage detector 560 as inputs. Upon PWM-1 (211-1) transitioning to hi-Z in response to stage 220-1 being made inactive, transmit block 570 reads signal 563, and forwards signal 563 received from voltage detector 560 on path 575 (current-induced) to pin P52 (CS), which is connected to phase controller 210 by path CS-1 (213-1). In an embodiment, transmit block 570 transmits/forwards signal 563 indicating whether induced-current flows through body-diode 535 only once upon PWM-1 transitioning to hi-Z, and thereafter maintains the logic level on path 575 at logic LOW until then next time PWM-1 transitions to hi-Z.

It is noted that other techniques for detecting whether current is induced in the body-diode of an inactive stage can be used instead of detecting the voltage at SW node. For example, induced-current may be detected by sensing current-flow through the primary winding of the transformer of an inactive phase.

As noted above, when a power stage is driven to an inactive state, a loss of efficiency may occur due to current-flow through the body-diode of the LS switch of the inactive power stage.

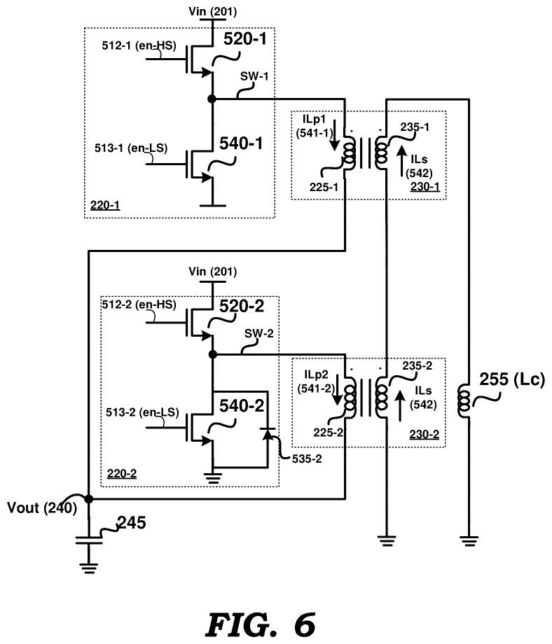

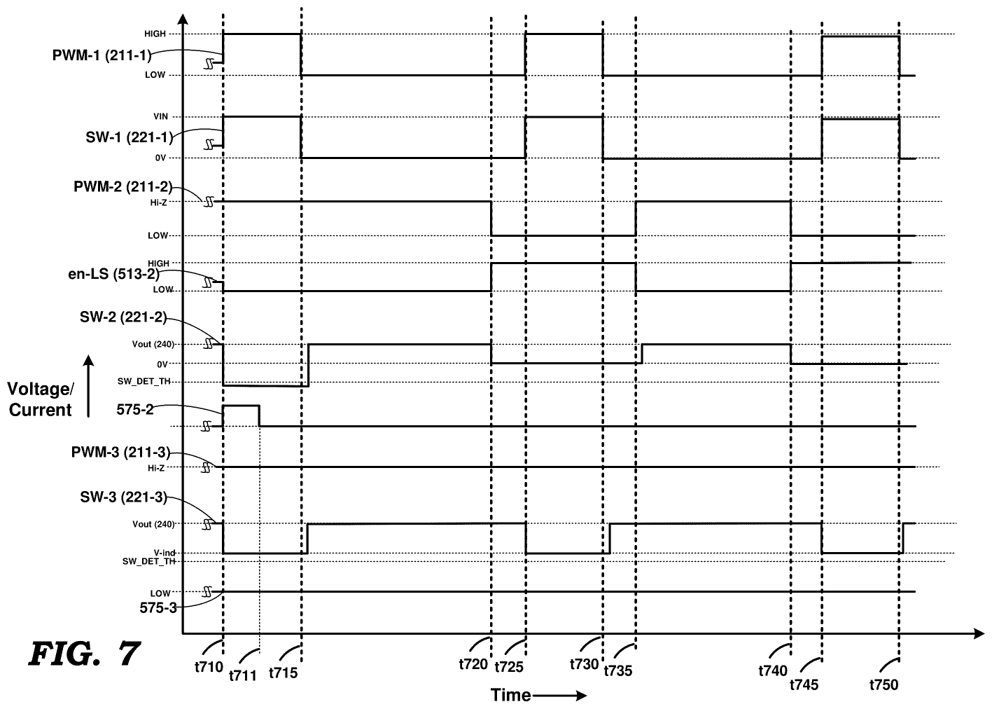

Currents and voltages at corresponding nodes of power stages (one active, the others inactive) in the presence of body-diode conduction in an inactive power stage are briefly illustrated next with reference to FIGS. 6 and 7.

### 7. Active and Inactive Power Stages

FIG. 6 is a block diagram showing SPSes 220-1 and 220-2 and the corresponding transformers and compensation inductor of TLVR 110. In the interest of clarity and ease of description, only two SPSes are shown in FIG. 6, which is shown containing SPS-1 (220-1), SPS-2 (220-2), transformers 230-1 and 230-2, capacitor 245 and compensation inductor 255. Only portions of SPSes 220 as relevant to the understanding of the present disclosure are depicted in FIG. 6. Other blocks (e.g., blocks 510, 530, 560, 570, etc. illustrated in FIG. 5) are not shown here in the interest of conciseness.

FIG. 7 is a timing diagram (not to scale) depicting example waveforms of signals PWM-1 (211-1), PMW-2 (211-2), PWM-3 (211-3), en-LS (513-2), voltages at switching nodes SW-1 (221-1), SW-2 (221-1), and SW-3 (221-3), and signals 575-2 and 575-3. SPS-1 (of FIG. 6) is assumed to be the active power stage while SPS-2 (of FIG. 6) and SPS-3 (not shown in FIG. 6) are assumed to be inactive. It is also assumed that current is induced in SPS-2 while no current is induced in SPS-3 due to active power stage SPS-1.

Just prior to time instant t710, it is assumed that a phase-change event has occurred as part of which, phase controller 210 determines to drive SPS-1 to an active state and SPS-2 and SPS-3 to an inactive state. Thus, time interval starting at time t710 may be referred to as a ‘first duration’, and such duration extends till the next phase-change event (not shown in FIG. 7).

At 710, phase controller 210 sets signal PWM-1 (211-1) of SPS 220-1 (‘active’ SPS) to logic HIGH and PWM signal of SPSes 220-2 and 220-3 (‘inactive’ SPSes) to hi-Z. Accordingly, a sequence of cycles of PWM signal PWM-1 (211-1) is depicted in FIG. 7. Time intervals t710-t725, t725-t745 depict two PWM cycles (i.e., cycles of signal PWM-1 (211-1)). Thus, time interval t710-t725 is the first cycle in the first duration, and t725-t745 is the second cycle in the first duration, and so on.

In interval t710-t715 of FIG. 7, PWM-1 is at logic HIGH, thereby switching ON MOSFET 520-1 and switching OFF MOSFET 540-1. Accordingly, voltage at node SW-1 (221-1) is pulled up towards Vin (201) and current ILp1 (541-1) (not shown in FIG. 7) starts flowing (increasing) through primary winding (225-1) of transformer 230-1. Current ILp1 (541-1) induces current in secondary winding (235-1) of transformer 230-1 and thus the secondary-loop.

Current flowing through the secondary loop induces an emf across primary windings (225) of the inactive power stages. The magnitude of the induced emf depends on factors such as Vin, Vout, number of active/inactive phases, the respective mutual inductances in the transformers, magnitude of compensation inductor 255, etc. If the magnitude of the induced emf is such that voltage at SW node of an inactive power stage exceeds the cut-in voltage (shown as SW_DET_TH in FIG. 7) of body-diode of LS switch of the inactive power stage, then a current is induced in the corresponding primary winding of the inactive power stage. However, if the magnitude of the induced emf is such that voltage at SW node is less than the body-diode cut-in voltage, then no current is induced in the primary winding of the inactive power stage. In an embodiment, SW_DET_TH equals −0.7V.

The description is continued to illustrate the two cases—when a current is induced in an inactive power stage and when no current is induced in an inactive power stage.

### A. Current Induced in an Inactive Power Stage

In interval t710-t715 of FIG. 7, signal PWM-2 is at hi-Z, thereby causing a logic LOW on path 513-2 (not shown in FIG. 7). Due to the induced emf noted above, the magnitude of voltage at SW-2 node (221-2) of inactive power stage SPS-2 becomes negative (in interval t710-t715) with a magnitude exceeding threshold voltage (SW-DET-TH), and an induced current ILp2(541-2) flows in primary winding (225-2) of transformer 230-2 associated with SPS-2 (220-2), with the induced current flowing through body-diode 535-2.

Referring to FIG. 5, when PWM-2 (211-2) is driven to hi-Z state and voltage at SW-2 becomes less than or equal to SW_DET_TH, voltage detector 560 generates a logic HIGH on path 563. Therefore, transmit block of SPS 220-2 (the inactive power stage) transmits a logic HIGH (in interval t710-t711) on path 575-2, and to phase controller 210. Although signal 563 is shown to be asserted at t710, detection of induced current and transmission of such information to phase controller 210 can happen anytime between t710-t715 (i.e., in the first PWM cycle of the first duration).

It is assumed that the pre-determined wait duration noted above corresponds to time interval t710-t715. Thus, in the illustrative embodiment, phase controller 210 (specifically, phase manager 430) stores the value (in this case logic HIGH) of signal 575-2 in memory 430 for SPS-2 (220-2).

Conduction of current through the body-diode of an inactive SPS leads to power dissipation, thus resulting in loss of efficiency in the multi-phase switching converter. Therefore, it is desirable to prevent or at least minimize conduction of current through the body-diode.

In interval t715-t725 of FIG. 7, with respect to SPS-1 (220-1), the logic LOW on PWM-1 (211-1) causes a logic LOW on path 512-1 (en-HS) and a logic HIGH on path 513-1 (en-LS) thereby switching OFF MOSFET 520-1 and switching ON MOSFET 540-1. Accordingly, voltage at node SW-1 (221-1) is pulled down towards ground (zero Volts) and current ILp1 (541-1) through primary winding (225-1) of transformer 230-1 starts decreasing. At some time point later than t715, the voltage at SW-2 returns to being at Vout. In FIG. 7, this time point is assumed for simplicity to be slightly later than t715.

Phase controller 210 reads the value of the logic bit stored in memory 430 for SPS-2 (220-2), the logic bit (which is now a logic HIGH) indicating that an induced current was detected in inactive stage 220-2. Therefore, for all subsequent PWM cycles of SPS-1 in the first duration, before transitioning signal PWM-1 (211-1) to logic HIGH (only two transitions occurring at time instants t725 and t745 are shown in FIG. 5), phase controller 210 transitions signal PWM-2 (211-2) of inactive SPS (220-2) to logic LOW (two transitions are shown at time instants t720 and t740 in FIG. 7) by transitioning PWM-2 to logic LOW, thereby causing turning-ON LS-switch 540-2 of SPS-2 (220-2) before turning on HS-switch 520-1 of SPS-1 (220-1).

Further, phase controller 210 transitions signal PWM-2 (211-1) to hi-Z (one such transition occurring at time instant t735 is shown in FIG. 7) thereby turning OFF LS-switch 540-2, after transitioning signal PWM-1 (211-1) to logic LOW (two such transitions are shown at time instants t730 and t750 in FIG. 5). Accordingly, voltage at SW-2 is shown at zero Volts in interval t720-t735 (when LS-switch 540-2 is ON), and at Vout in interval t735-t740 (when LS-switch 540-2 is OFF).

It may be appreciated that turning-ON LS-switch of the inactive SPS provides a low-resistance path for the current induced in the inactive SPS. Since RDS-ON (ON-resistance of LS switch) is low (of the order of a few milli Ohms), power dissipation due to the induced current is lower than if it were to flow through the body-diode (which is OFF when the LS-switch is ON) of the LS-switch.

Although the illustrative embodiment depicts inactive power stage SPS-2 (220-2) as detecting and communicating presence of induced current in a first cycle of signal PWM-1 (211-1) immediately following a phase-change event, in alternative embodiments, SPS-2 (220-2) may perform such detection and communicating in later cycles (e.g., third or fourth cycle of PWM-1 (211-1). In such alternative embodiments, phase controller 210 maintains signal PWM-2 (211-2) in hi-Z state until such detection is communicated.

### B. Current is Not Induced in an Inactive Power Stage

It is noted herein that it is possible that a current may not be induced at all in an inactive power stage despite the electromagnetic coupling of the outputs of the power stage. As noted above, the magnitude of induced current and whether current is induced at all in an inactive power stage depends on factors such as, for example, the number of active phases, the respective mutual inductances in the transformers, ratio of voltages Vout and Vin, etc.

Referring now to SPS-3, in interval t710-t715 of FIG. 7, signal PWM-3 is at hi-Z, thereby causing a logic LOW on path 513-3 (not shown in FIG. 7). Due to the induced emf noted above, magnitude of voltage at SW-3 node (221-3) of inactive power stage SPS (220-3) becomes negative (magnitude V-ind) in interval t710-t715. However, voltage at SW-3 does not exceed threshold voltage (SW-DET-TH), thereby current is not induced in the primary winding of the transformer associated with SPS-3 (220-3). Accordingly, signal 575-3 continues to be at logic LOW.

At the end of the pre-determined wait duration noted above (i.e., by t715), phase controller 210 stores a logic LOW for signal 575-3, and continues to maintain PWM-3 (211-3) in hi-Z state for all subsequent PWM cycles of SPS-1 in the first duration (i.e., until a next phase-change event occurs).

In interval t715-t725 of FIG. 7, with respect to inactive phase SPS-3 (220-3), since no current is induced in the primary winding of the transformer, voltage at SW-3 node (221-3) of inactive SPS (220-3) is at Vout.

Phase controller 210 may pre-determine length of intervals t720-t725 and t730-t735 (as well as other similar intervals) based on factors such as delays in the SPS and phase controller 210.

Although not shown in FIG. 7, phase controller 210 drives the control signals of other inactive SPSes in a similar manner based on whether or not current is induced in the inactive SPSes, as described above.

When multiple power stages are active in a particular duration bounded by two consecutive phase-change events, corresponding PWM signals of active power stages are staggered. Phase controller 120 may operate to turn-ON the HS-switches of the active stages in a round-robin sequence, as is well known in the relevant arts. In such scenarios, induced current may be detected in the inactive power stage(s) in the very first cycle of the PWM signal of the first active power stage in the sequence. Phase controller 120 toggles the PWM signals of the inactive power stage(s) from hi-Z to logic LOW and from logic-LOW to hi-Z around (i.e., encompassing) HIGH-to-LOW and immediately subsequent LOW-to-HIGH transitions of each of the PWM signals of the active stages.

The description is continued to illustrate an example implementation of a voltage detector in an embodiment of the present disclosure.

### 8. Voltage Detector

FIG. 8 is a block diagram of a voltage detector implemented in a power stage, in an embodiment of the present disclosure. Voltage detector 560 is shown containing current sources 810 and 825, resistor 820, N-channel MOSFETs (NMOS) 830 and 840, and inverter 850. Magnitude of voltage V1 (802) equals (gate-source) threshold voltage (Vt1) of transistor 830 plus a small voltage, Vdelta1 (by which the voltage at gate of transistor 830 exceeds Vt1).

Due to the voltage drop (Vdelta2) across resistor 820, gate voltage (V2, 804) of transistor 840 will be equal to V1 (802) minus Vdelta2. The magnitude of resistor 820 is implemented such that V2 (804) minus (cut-in voltage of body-diode 535 of low-side switch of SPS 220) is close to (gate-source) threshold voltage (Vt2) of transistor 840. In an embodiment, V2=Vt2 minus 0.7V.

Thus, when voltage SW-1 is greater than (−0.7) V, transistor 840 is switched OFF, and output 563 of inverter 850 is a logic LOW. However, when SW-1 (221-1) is less than or equal to (−0.7) V, transistor 840 is switched ON, and output 563 of inverter 850 is a logic HIGH.

Although the illustrative embodiment is shown employing the circuit of FIG. 8 in order to detect voltage at the SW node, it may be appreciated that alternative embodiments may employ different circuit(s) for such voltage detection.

Thus, the techniques of the present disclosure determine presence or absence of induced current in an inactive power stage only once upon occurrence of a phase-change event, and thereafter use the result of the determination in subsequent cycles to switch-ON (and switch-OFF) the low-side switch of the inactive power stage as noted above until the next phase-change event occurs.

In this manner, aspects of the present disclosure provide a technique for managing loss of efficiency due to an inactive power stage of a multi-phase switching converter.

### 9. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 4, 5, 6 and 8, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors with similar characteristics will be apparent to one skilled in the relevant arts by reading the disclosure provided herein.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

1. A multi-phase switching converter to generate a regulated supply voltage on a supply node from an input power source coupled to an input node, said multi-phase switching converter comprising:
a plurality of power stages, each power stage having a high-side switch and a low-side switch coupled in series at a switching (SW) node; and
a phase controller to generate a plurality of control signals to drive said plurality of power stages,
wherein said phase controller operates to drive a first set of power stages to an active state and a second set of power stages to an inactive state in a first sequence of cycles of a first duration, said first set of power stages and said second set of power stages comprised in said plurality of power stages,
wherein said phase controller operates to drive a first power stage of said first set of power stages to said active state in said first duration by switching a first control signal of said plurality of control signals between a first state and a second state in each cycle of said first sequence of cycles,
wherein said phase controller operates to drive a second power stage of said second set of power stages to said inactive state at a first time instance in said first duration by driving a second control signal of said plurality of control signals to a high-impedance (hi-Z) state,
if an error current is detected in said second power stage at a second time instance following said first time instance in said first duration, said phase controller transitions said second control signal of said second power stage to said second state before each transition of said first control signal from said second state to said first state in each cycle of said first sequence of cycles following said second time instance; and
if said error current is not detected in said second power stage at said second time instance, said phase controller maintains said second control signal in said hi-Z state following said second time instance in said first duration.

2. The multi-phase switching converter of claim 1, wherein if said error current is detected in said second power stage, said phase controller transitions said second control signal to said hi-Z state from said second state after each transition of said first control signal to said second state from said first state in each cycle of said first sequence of cycles following said second time instance.

3. The multi-phase switching converter of claim 1, wherein said first power stage and said second power stage are electromagnetically coupled, wherein said first state and said second state respectively comprise a logic HIGH state and a logic LOW state,
wherein said first duration starts at said first time instance, wherein said second power stage detects said error current when said control signal of said first power stage is in said first state in a first cycle of said first sequence of cycles immediately following said first time instance,
wherein said second power stage communicates said detection to said phase controller at said second time instance in said first cycle via an error-detected signal, wherein a first logic level of said error-detected signal indicates the presence of said error current, an inverse of said first logic level indicating otherwise,
wherein said phase controller, in response to said communication of detection at said second time instance, stores the logic state of said error-detected signal corresponding to said second power stage in a memory located internal to said phase controller,
wherein said phase controller drives said second control signal in each cycle of said first sequence of cycles following said second time instance based on the logic state stored in said memory.

4. The multi-phase switching converter of claim 3, wherein said first duration is a time interval bounded by two consecutive phase-change events, wherein said multi-phase switching converter comprises:
a plurality of transformers; and
a compensation inductor,
wherein each of said plurality of power stages is coupled to one end of a primary winding of a respective transformer of said plurality of transformers, with the other end of the primary winding being coupled to said supply node, wherein the secondary windings of said plurality of transformers and said compensation inductor form a secondary-loop between a pair of constant reference potential terminals,
wherein said error current is a current induced in the primary winding of the transformer of said second power stage, and which flows through a body-diode of said low-side switch of said second power stage.

5. The multi-phase switching converter of claim 4, wherein said second power stage detects said error current by checking if a voltage at said SW node exceeds a pre-determined magnitude.

6. The multi-phase switching converter of claim 5, wherein each power stage of said plurality of power stages comprises:
a high-side driver block operable to drive a control terminal of said high-side switch by a high-side drive signal, said high-side drive signal derived from a corresponding control signal of said plurality of control signals to cause said high-side switch to be ON or OFF;
a low-side driver block operable to drive a control terminal of said low-side switch by a low-side drive signal, said low-side drive signal derived from said corresponding control signal to cause said low-side switch to be ON or OFF;
a voltage detector operable to perform said checking; and
a control logic block operable to communicate said detection of said error current to said phase controller,
wherein:
when said corresponding control signal is in said first state, said high-side drive signal is a logic HIGH and said low-side drive signal is a logic LOW, said high-side switch is ON and said low-side switch is OFF,
when said corresponding control signal is in said second state, said high-side drive signal is a logic LOW and said low-side drive signal is a logic HIGH, said high-side switch is OFF and said low-side switch is ON,
when said corresponding control signal is in said hi-Z state, both of said high-side drive signal and said low-side drive signal are logic LOW, and both of said high-side switch and said low-side switch are OFF.

7. The multi-phase switching converter of claim 6, wherein said voltage detector comprises:
a first switch;
a second switch;
a resistor;
an inverter;
a first current source, wherein said first switch is coupled between a first constant reference potential and a first end of said first current source, wherein said first current source is coupled between said switch and a first end of said resistor;
a first transistor, wherein a first current terminal of said first transistor is coupled to a second end of said resistor, wherein a second current terminal of said first transistor is coupled to a second constant reference potential, wherein a control terminal of said first transistor is coupled to the junction of said first current source and said first end of said resistor;
a second transistor, wherein a control terminal of said second transistor is coupled to said second end of said resistor, wherein a first current terminal of said second transistor is coupled to an input of an input of said inverter, wherein a second current terminal of said second transistor is coupled to said SW node; and
a second current source, wherein said second switch is coupled between said first constant reference potential and a first end of said second current source, wherein said second current source is coupled between said second switch and said input of said inverter,
wherein a logic HIGH at an output of said inverter indicates that said voltage at said switching node exceeds said pre-determined magnitude, and a logic LOW at said output of said inverter indicates otherwise.

8. A method performed in a phase controller of a multi-phase switching converter, said multi-phase switching converter to generate a regulated supply voltage from an input voltage, said multi-phase switching converter comprising a plurality of power stages, each power stage having a high-side switch and a low-side switch coupled in series at a switching (SW) node, said method comprising:
driving a first power stage of said plurality of power stages to an active state in said first duration by switching a first control signal of said first power stage between a first state and a second state in a first sequence of cycles of a first duration;
driving a second power stage of said plurality of power stages to an inactive state at a first time instance in said first duration by driving a second control signal of said second power stage to a high-impedance (hi-Z) state,
if an error current is detected in said second power stage at a second time instance following said first time instance in said first duration, transitioning said second control signal to said second state before each transition of said first control signal from said second state to said first state in each cycle of said first sequence of cycles following said second time instance; and
if said error current is not detected in said second power stage at said second time instance, maintaining said second control signal in a high-impedance (hi-Z) state following said second time instance in said first duration.

9. The method of claim 8, if said error current is detected in said second power stage, transitioning said second control signal to said hi-Z state from said second state after each transition of said first control signal to said second state from said first state in each cycle of said first sequence of cycles following said second time instance.

10. The method of claim 8, wherein said first power stage and said second power stage are electromagnetically coupled, wherein said first state and said second state respectively comprise a logic HIGH state and a logic LOW state,
wherein said first duration starts at said first time instance, wherein said second power stage detects said error current when said first control signal is in said first state in a first cycle of said first sequence of cycles immediately following said first time instance,
wherein said second power stage communicates said detection to said phase controller at said second time instance in said first cycle via an error-detected signal, wherein a logic state of HIGH of said error-detected signal indicates the presence of said error current, and a logic state of LOW of said error-detected signal indicates otherwise,
wherein said method further comprises:
in response to said communication of detection at said second time instance, storing the logic state of said error-detected signal corresponding to said second power stage in a memory located internal to said phase controller; and
driving said second control signal in each cycle of said first sequence of cycles following said second time instance based on the logic state stored in said memory.

11. The method of claim 10, wherein said first duration is a time interval bounded by two consecutive phase-change events, wherein said multi-phase switching converter comprises:
a plurality of transformers; and
a compensation inductor,
wherein each of said plurality of power stages is coupled to one end of a primary winding of a respective transformer of said plurality of transformers, with the other end of the primary winding being coupled to said supply node, wherein the secondary windings of said plurality of transformers and said compensation inductor form a secondary-loop between a pair of constant reference potential terminals,
wherein said error current is a current induced in the primary winding of the transformer of said second power stage which flows through a body-diode of said low-side switch of said second power stage.

12. The method of claim 10, wherein said second power stage detects said error current by checking if a voltage at said SW node exceeds a pre-determined magnitude.

13. The method of claim 12, wherein each power stage of said plurality of power stages comprises:
a high-side driver block operable to drive a control terminal of said high-side switch by a high-side drive signal, said high-side drive signal derived from a corresponding control signal to cause said high-side switch to be ON or OFF;
a low-side driver block operable to drive a control terminal of said low-side switch by a low-side drive signal, said low-side drive signal derived from said control signal to cause said low-side switch to be ON or OFF;
a voltage detector operable to perform said checking; and
a control logic block operable to communicate said detection of said error current to said phase controller,
wherein:
when said corresponding control signal is in said first state, said high-side drive signal is a logic HIGH and said low-side drive signal is a logic LOW, said high-side switch is ON and said low-side switch is OFF,
when said corresponding control signal is in said second state, said high-side drive signal is a logic LOW and said low-side drive signal is a logic HIGH, said high-side switch is OFF and said low-side switch is ON,
when said corresponding control signal is in said hi-Z state, both of said high-side drive signal and said low-side drive signal are logic LOW, and both of said high-side switch and said low-side switch are OFF.

14. The method of claim 13, wherein said voltage detector comprises:
a first switch;
a second switch;
a resistor;
an inverter;
a first current source, wherein said first switch is coupled between a first constant reference potential and a first end of said first current source, wherein said first current source is coupled between said switch and a first end of said resistor;
a first transistor, wherein a first current terminal of said first transistor is coupled to a second end of said resistor, wherein a second current terminal of said first transistor is coupled to a second constant reference potential, wherein a control terminal of said first transistor is coupled to the junction of said first current source and said first end of said resistor;
a second transistor, wherein a control terminal of said second transistor is coupled to said second end of said resistor, wherein a first current terminal of said second transistor is coupled to an input of an input of said inverter, wherein a second current terminal of said second transistor is coupled to said SW node; and
a second current source, wherein said second switch is coupled between said first constant reference potential and a first end of said second current source, wherein said second current source is coupled between said second switch and said input of said inverter,
wherein a logic HIGH at an output of said inverter indicates that said voltage at said switching node exceeds said pre-determined magnitude, and a logic LOW at said output of said inverter indicates otherwise.

15. A phase controller of a multi-phase switching converter, said multi-phase switching converter operable to generate a regulated supply voltage on a supply node from an input power source coupled to an input node, said phase controller to generate a plurality of phase control signals to drive respective power stages of a plurality of power stages of said multi-phase switching converter, each power stage having a high-side switch and a low-side switch coupled in series at a switching (SW) node, said phase controller comprising:
a control block to generate a master control signal based at least on a magnitude of said regulated supply voltage;
a phase manager to generate said plurality of phase control signals from said master control signal; and
a memory,
wherein said phase manager drives a first set of power stages to an active state and a second set of power stages to an inactive state in a first sequence of cycles of a first duration, said first set of power stages and said second set of power stages comprised in said plurality of power stages,
wherein said phase manager operates to drive a first power stage of said first set of power stages to said active state in said first duration by switching a first phase control signal of said plurality of phase control signals between a first state and a second state in each cycle of said first sequence of cycles,
wherein said phase manager operates to drive a second power stage of said second set of power stages to said inactive state at a first time instance in said first duration by driving a second phase control signal of said plurality of phase control signals to a high-impedance (hi-Z) state,
if an error current is detected in said second power stage at a second time instance following said first time instance in said first duration, said phase manager transitions a second phase control signal of said second power stage to said second state before each transition of said first phase control signal from said second state to said first state in each cycle of said first sequence of cycles following said second time instance; and
if said error current is not detected in said second power stage at said second time instance, said phase controller maintains said second phase control signal in said high-impedance (hi-Z) state following said second time instance in said first duration.

16. The phase controller of claim 15, if said error current is detected in said second power stage, said phase manager transitions said second phase control signal to said hi-Z state from said second state after each transition of said first phase control signal to said second state from said first state in each cycle of said first sequence of cycles following said second time instance.

17. The phase controller of claim 15, wherein said first power stage and said second power stage are electromagnetically coupled, wherein said first state and said second state respectively comprise a logic HIGH state and a logic LOW state,
wherein said first duration starts at said first time instance, wherein said second power stage detects said error current when said first phase control signal is in said first state in a first cycle of said first sequence of cycles immediately following said first time instance,
wherein said second power stage communicates said detection to said phase manager at said second time instance in said first cycle via an error-detected signal, wherein a first logic level of said error-detected signal indicates the presence of said error current, an inverse of said first logic level indicating otherwise,
wherein said phase manager, in response to said communication of detection at said second time instance, stores the logic state of said error-detected signal corresponding to said second power stage in said memory,
wherein said phase manager drives said second phase control signal in each cycle of said first sequence of cycles following said second time instance, based on the logic state stored in said memory.

18. The phase controller of claim 17, wherein said first duration is a time interval bounded by two consecutive phase-change events, wherein said multi-phase switching converter comprises:
a plurality of transformers; and
a compensation inductor,
wherein each of said plurality of power stages is coupled to one end of a primary winding of a respective transformer of said plurality of transformers, with the other end of the primary winding being coupled to said supply node, wherein the secondary windings of said plurality of transformers and said compensation inductor form a secondary-loop between a pair of constant reference potential terminals,
wherein said error current is a current induced in the primary winding of the transformer of said second power stage, and which flows through a body-diode of said low-side switch of said second power stage.

19. The phase controller of claim 18, wherein said second power stage detects said error current by checking if a voltage at said SW node exceeds a pre-determined magnitude.

20. The phase controller of claim 19, wherein each power stage of said plurality of power stages comprises:
a high-side driver block operable to drive a control terminal of said high-side switch by a high-side drive signal, said high-side drive signal derived from a corresponding phase control signal of said plurality of phase control signals to cause said high-side switch to be ON or OFF;
a low-side driver block operable to drive a control terminal of said low-side switch by a low-side drive signal, said low-side drive signal derived from said corresponding phase control signal to cause said low-side switch to be ON or OFF;
a voltage detector operable to perform said checking; and
a control logic block operable to communicate said detection of said error current to said phase controller,
wherein:
when said corresponding phase control signal is in said first state, said high-side drive signal is a logic HIGH and said low-side drive signal is a logic LOW, said high-side switch is ON and said low-side switch is OFF,
when said corresponding phase control signal is in said second state, said high-side drive signal is a logic LOW and said low-side drive signal is a logic HIGH, said high-side switch is OFF and said low-side switch is ON,
when said corresponding phase control signal is in said hi-Z state, both of said high-side drive signal and said low-side drive signal are logic LOW, and both of said high-side switch and said low-side switch are OFF.
